(19) United States
(12) Patent Application Publication
(10) Pub. No.: US 2016/0126677 A1
(43) Pub. Date: May 5, 2016

(54) ELECTRICAL CONNECTOR

(71) Applicant: ALLTOP ELECTRONICS (SUZHOU) LTD., Taicang City (CN)

(72) Inventors: Wang-I YU, Jhonghe City (TW); Mao-Jung HUANG, Jhonghe City (TW)

(73) Assignee: ALLTOP ELECTRONICS (SUZHOU) LTD., Taicang City (CN)

(21) Appl. No.: 14/809,380

(22) Filed: Jul. 27, 2015

(30) Foreign Application Priority Data
Nov. 5, 2014 (CN) 201410613243.2

(51) Int. Cl. H01R 13/6581; H01R 24/60

(52) U.S. Cl. CPC H01R 13/6581; H01R 24/60; H01R 2107/00

(57) ABSTRACT

An electrical connector includes an insulative housing and a plurality of contacts retained in the insulative housing. The insulative housing has a body portion and a mating portion forwardly extending from the body portion. each contact has a contact portion exposed on the mating portion and an extension portion extending backwardly from a rear end of the contact portion. The contacts comprise signal contacts, and in a transverse direction of the insulative housing, the contact portions of the signal contacts are wider than the extension portions of the signal contacts.

### BACKGROUND

1. Technical Field

The present disclosure relates to an electrical connector, and more particularly to an electrical connector with improved contacts.

2. Description of Related Art

Electrical connectors, such as Universal Serial Bus (USB), HDMI etc. are widely used on various consumer electronic products. The electrical connectors usually include a number of terminals, an insulative housing supporting the terminals and a shield covering the insulative housing. For producing conveniently, the terminals have same width from a front mating end to a rear soldering end. Due to continuing trend toward miniaturization and improved electrical performance by electronics industry, requirement for greater contact density and higher electrical speeds are constantly being promulgated. However, it is laborious and troublesome to assemble the terminals to the insulative housing. One solution to this problem is securing the terminals to the insulative housing by insert-molding. However, the density arrangement of the terminals causes the melting plastic material can't be full molded between the terminals.

It is desirable to provide an improved electrical connector for solving above problems.

### SUMMARY

In one aspect, the present invention includes an electrical connector. The electrical connector comprises an insulative housing having a body portion and a mating portion forwardly extending from the body portion; a plurality of contacts retained in the insulative housing, each contact having a contact portion exposed on the mating portion and an extension portion extending backwardly from a rear end of the contact portion; wherein the contacts comprise signal contacts, and in a transverse direction of the insulative housing, the contact portions of the signal contacts are wider than the extension portions of the signal contacts.

In another aspect, the present invention further includes an electrical connector. The electrical connector comprises an insulative housing having a body portion and a mating portion forwardly extending from the body portion; a plurality of contacts retained in the insulative housing, each contact having a contact portion exposed on the mating portion and an extension portion extending backwardly from a rear end of the contact portion; wherein the contacts comprise signal contacts and grounding contacts two sides of the signal contacts, and in a transverse direction of the insulative housing, the contact portions of the signal contacts and the grounding contacts have same width, and the extension portions of the signal contacts are narrower than that of the grounding contacts.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view illustrating a first embodiment of an electrical connector in the present disclosure;

FIG. 2 is an exploded view of the electrical connector shown in FIG. 1;

FIG. 3 is perspective view of the insulative housing of the electrical connector shown in FIG. 2;

FIG. 4 is a view similar to FIG. 3, while viewed from another aspect;

FIG. 5 is a perspective view of the contacts of the electrical connector shown in FIG. 2;

FIG. 6 is a perspective view of the middle grounding member of the electrical connector shown in FIG. 2;

FIG. 7 is a perspective view of the inner shell of the electrical connector shown in FIG. 2;

FIG. 8 is a perspective view of the outer shell of the electrical connector shown in FIG. 2;

FIG. 9 is a perspective view illustrating a second embodiment of an electrical connector in the present disclosure;

FIG. 10 is a perspective view of the contacts of the electrical connector shown in FIG. 9.

### DETAILED DESCRIPTION OF THE ILLUSTRATED EMBODIMENT

Reference will now be made to the drawing figures to describe the embodiments of the present disclosure in detail. In the following description, the same drawing reference numerals are used for the same elements in different drawings.

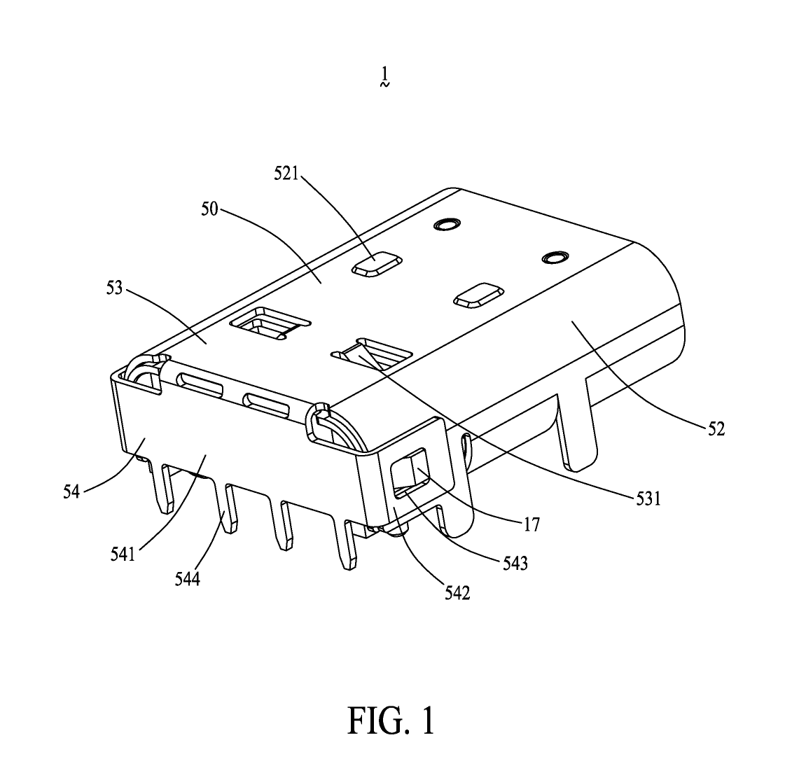

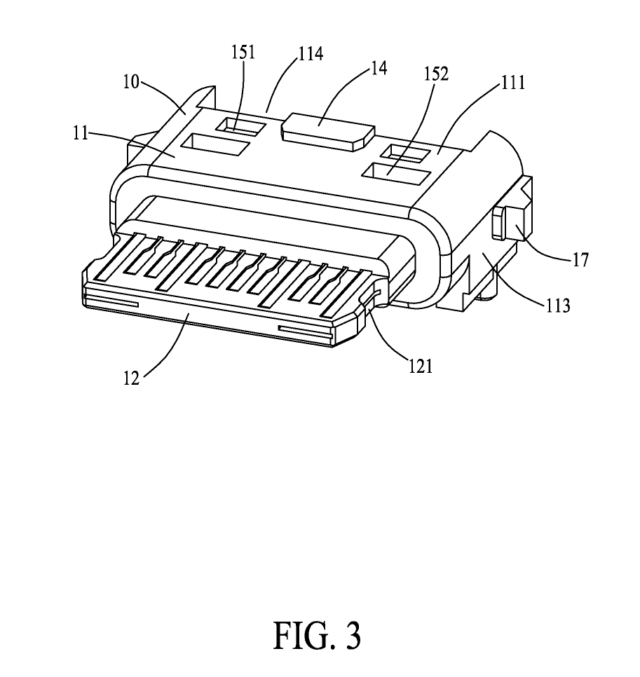

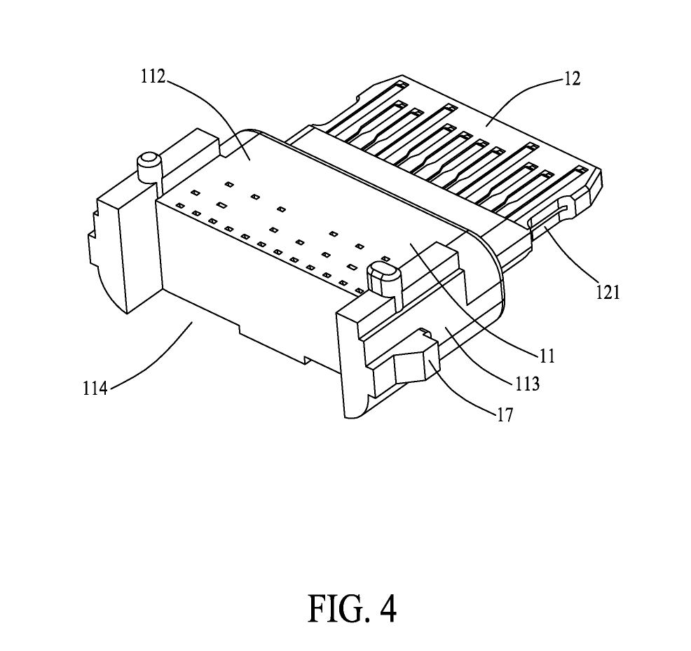

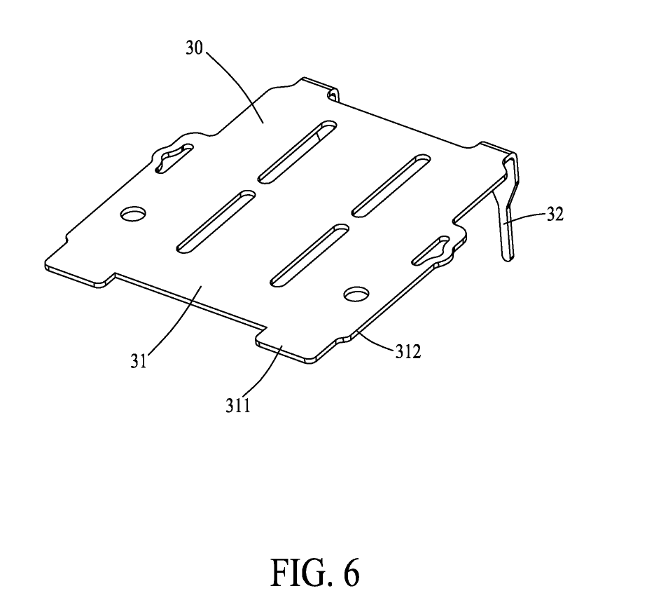

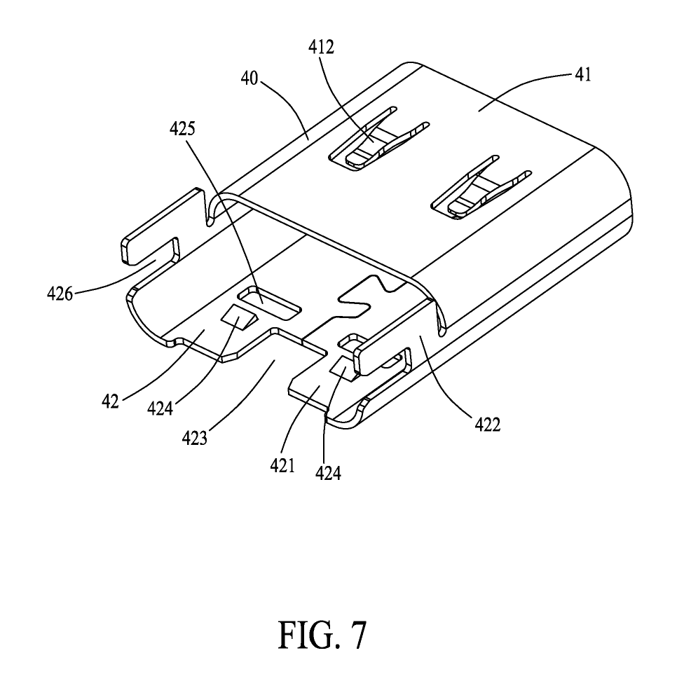

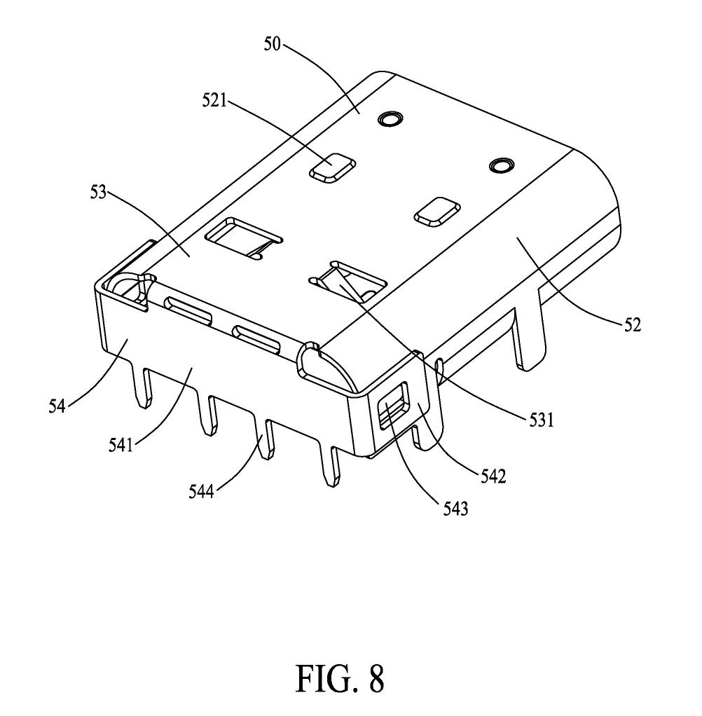

Referring to FIGS. 1 to 8, a first illustrated embodiment of the present disclosure discloses an electrical connector 1. The electrical connector 1 comprises an insulative housing 10, a plurality of contacts 20 and a middle grounding member 30 retained in the insulative housing 10, an inner shell 40 surrounding the insulative housing 10, and an outer shell 50 covering the inner shell 40.

Referring to FIGS. 1 to 4, the insulative housing 10 is provided with a body portion 11 and a mating portion 12 forwardly extending from the body portion 11. The mating portion 12 in the present embodiment is a mating tongue. The mating tongue 12 is thinner than the body portion 11, and defines two locking recesses 121 at two sides thereof. The contacts 20 are arranged in two rows which comprise an upper row 201 and a lower row 202. The upper row 201 and lower row 202 are correspondingly located at upper and lower sides of the mating tongue 12. The contacts 20 are insert-molded in the insulative housing 10.

The body portion 11 is provided with a top wall 111, a bottom wall 112 opposite to the top wall 111, and two side walls 113 connecting two sides of the top wall 111 and the bottom wall 112. The top wall 111 is formed with a protrusion 14 and two pairs of recesses at two sides of the protrusion 14. The recesses include a pair of first recesses 151 and a pair of second recesses 152 at front of the first recesses 151. The first recesses 151 are smaller and shallower than the second recesses 152. The first recesses 151 and the protrusion 14 are located at a same line in a transverse direction of the insulative housing 10.

Besides, the body portion 11 defines a limiting space 114 at rear end thereof. The protrusion 14 and the first recesses 151 are close to the limiting space 114. The side walls 113 are provided with limiting blocks 17 at rear sides thereof. The limiting blocks 17 are located at two sides of the limiting space 114.

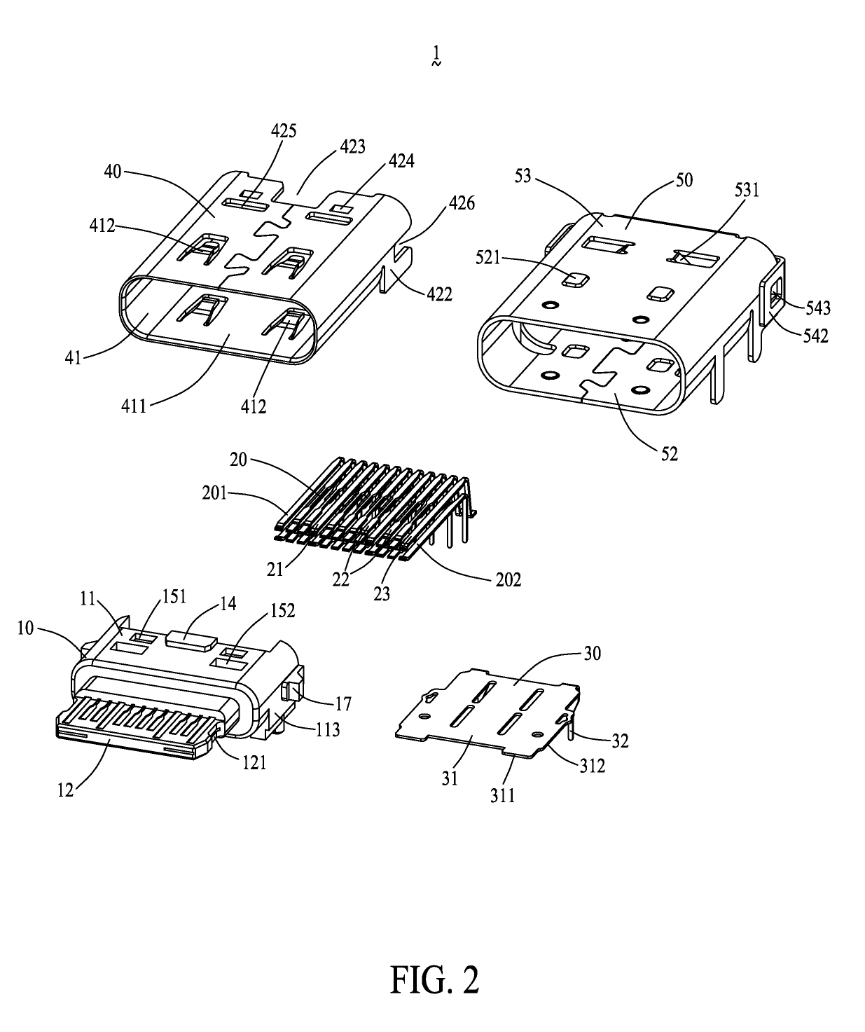

Referring to FIGS. 2 to 5, each contact 20 has a contact portion 203 exposed on the mating portion 12, a front end 204 extending forwardly, an extension portion 205 extending backwardly from a rear end of the contact portion 203, a connecting portion 206 extending from a rear end of the extension portion 205 and a tail portion 207 extending from a rear end of the connecting portion 206. The front ends 204 are insert-molded in the front end of the mating tongue 12. The contact portions 203 and the front part of the extension portions 205 in the upper row 201 and lower row 202 are inlayed in upper and lower sides of the mating tongue 12, and exposed outwardly. A rear part of each extension portion 205 and the connecting portions 206 are insert-molded in the body portion 11. The tail portions 207 extend out of the insulative housing 10 to connect with a circuit board (not shown).

Besides, the connecting portion 206 has a level portion 2061 and a bending portion 2062. The level portion 2061 and the extension portion 205 on each contact 20 connect with each other and are located in a plane. The bending portion 2062 bends downwardly from a rear end of the level portion 2061 and connects with the tail portion 207. The bending portions 2062 of the contacts 20 in the upper row 201 are located behind that in the lower row 202. The tail portions 207 of the contacts 20 in the upper row 201 extends backwardly from lower ends of the bending portions 2062, while the tail portions 207 of the contacts 20 in the lower row 202 extends downwardly from lower ends of the bending portions 2061.

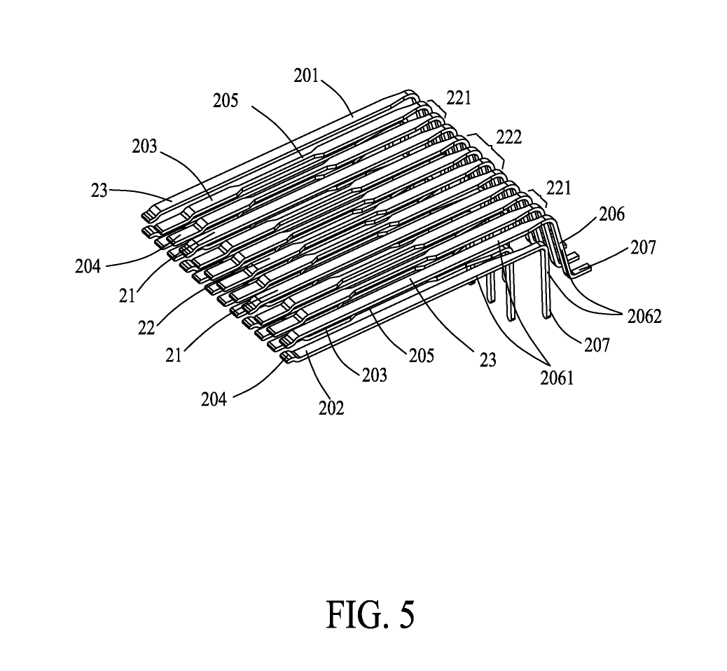

Referring to FIGS. 2 and 5, in the present embodiment, the contacts 20 comprise signal contacts 22, power contacts 21 and grounding contacts 23. The signal contacts 22 comprise superspeed differential signal contacts 221 and low-frequency signal contacts 222. In detail, the contacts 20 in each row 201, 202 comprise two grounding contacts 23 at two lateral sides, two pairs of superspeed differential signal contacts 221 adjacent two grounding contacts 23 respectively, two power contacts 21 arranged at internal side of the superspeed differential signal contacts 221, and four low-frequency signal contacts 222 between the power contacts 21; and the contacts 20 in two rows 201, 202 are identical in signal transmission except that they are arranged reversely.

Besides, the contact portions 203 of all contacts 20 have same width. The width of the level portions 2061 is same to that of the contact portions 203. The bending portions 2062 and tail portions 207 are narrower than the level portions 2061, which make the space between adjacent tail portions 207 is big enough to prevent disturb from each other. In a transverse direction of the insulative housing 10, the contact portions 203 of the signal contacts 22 are wider than the extension portions 205 of the signal contacts 22, and the width of the extension portion 205 of the signal contact 22 is thirty percent to seventy percent of the width of the corresponding contact portion 203. In the present embodiment, the contact portions 203 and the extension portions 205 of the grounding contacts 23 and the power contacts 21 have same width. Thereby the extension portions 205 of the signal contacts 22 are narrower than that of the grounding contacts 23 and the power contacts 21. The narrower width of the extension portions 205 of the signal contacts 22 brings the space between the contacts 20 be larger, which can make melting plastic material be full molded therebetween; besides, the narrower width of the extension portions 205 of the signal contacts 22 further provides a good impedance matching for high frequency signal transmission.

Referring to FIGS. 2, 3 and 6, the middle grounding member 30 is arranged between the upper and lower rows 201, 202 of the contacts 20, and is provided with a flat base portion 31, a pair of soldering legs 32 downwardly extending from a rear end of the base portion 31. The base portion 31 is insert-molded in the body portion 11 and mating tongue 12, and space apart from the contacts 20. The base portion 31 has a pair of flanges 311 extending forwardly from two sides of the front end thereof, and a pair of engaging portions 312 at two sides thereof. The flanges 311 protrude through the mating tongue 12. The engaging portions 312 expose in the locking recesses 121 to engage with a mating connector (not shown). The soldering legs 32 are used to electrically connect with the circuit board, therefore the middle grounding member 30 can prevent the upper and lower rows 201, 202 of contacts 20 from interfering with each other and performance to prevent EMI between the two rows of the contacts 20.

Referring to FIGS. 1, 2 and 7, the inner shell 40 is provided with a sleeve portion 41 and a shield portion 42 backwardly extending from the sleeve portion 41. The sleeve portion 41 surrounds the mating tongue 12. The sleeve portion 41 and the mating tongue 12 define a receiving space 411 therebetween. The distance between the mating tongue 12 and a top wall of the sleeve portion 41 is equal to the distance between the mating tongue 12 and a bottom wall of the sleeve portion 41, thereby, combining the arrangement of the contacts 20 on the mating tongue 12, the mating connector can mate with the electrical connector 1 in the pros and cons. Besides, the sleeve portion 41 is provided with two pairs of spring arms 412 protruding to the receiving space 411 from upper and lower sides thereof. The spring arms 412 are used to lock with locking holes formed on the mating connector.

The shield portion 42 has a first shield portion 421 covering the top surface of the body portion 11, a pair of second shield portions 422 downwardly extending from two sides of the first shield portion 421. The first shield portion 421 is formed with an opening 423 to receive the protrusion 14 on the body portion 11, a pair of barbs 424 projecting into the first recesses 151, and a pair of through holes 425 corresponding to the second recesses 152. The protrusion 14 can prevent the inner shell 40 from moving backwardly. The barbs 424 abut against the front inner walls of the first recesses 151 to prevent the inner shell 40 from moving forwardly. The second shield portions 422 define a pair of cutouts 426. The limiting blocks 17 on two sides of the body portion 11 engage with the cutouts 426 to limit the inner shell 40 from moving along a top to bottom direction.

Referring to FIGS. 2, 7 and 8, the outer shell 50 has an enclosure 52 enclosing the sleeve portion 41 and a rear portion 53 extending from the enclosure 52. Each of the top wall and bottom wall of the enclosure 52 is provided with a pair of dodge portions 521 protruding outwardly. The dodge portions 521 correspond to the spring arms 412 and supply a deforming space to the spring arms 412. The rear portion 53 opens downward, and is formed with a pair of tabs 531 corresponding to the through holes 425 of the inner shell 40. The tabs 531 extend through the through holes 425 and engage with the second recesses 152.

The outer shell 50 further has a U-shaped portion 54 connecting the rear portion 53. The U-shaped portion 54 has a rear wall 541 covering a rear end of the body portion 11 and a pair of locking barbs 542 forwardly extending from two sides of the rear wall 541. The locking barbs 542 are located at outsides of two side walls of the rear portion 53. The locking barbs 542 and the side walls of the rear portion 53 are provided with locking holes 543. The locking holes 543 lock with the limiting blocks 17 on two sides of the body portion 11. Besides, the rear wall 541 is formed with a number of legs 544 downwardly extending from a lower end thereof to fasten with the circuit board.

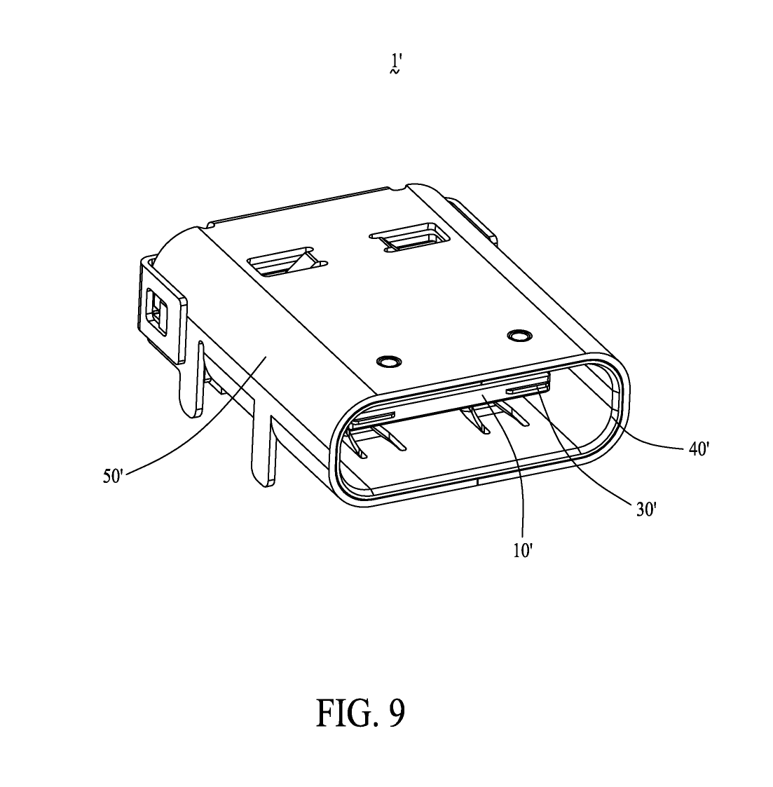

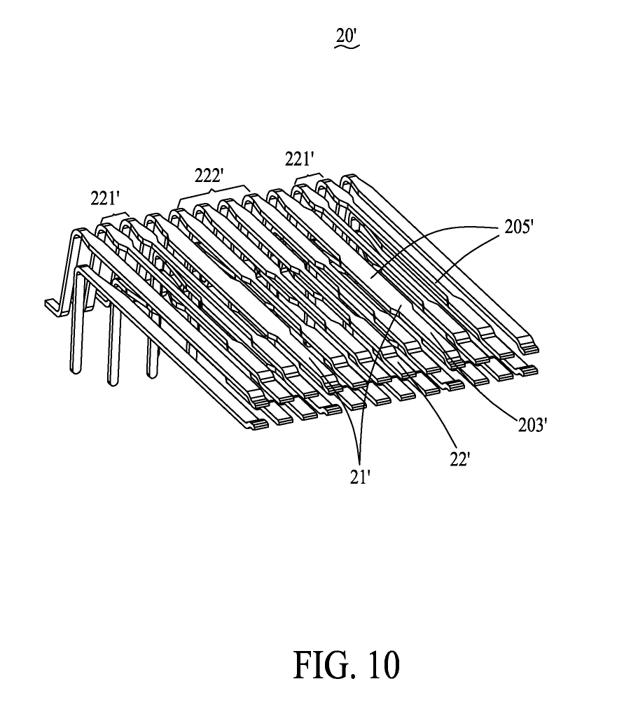

Referring to FIGS. 9 and 10, in accordance with a second preferred embodiment of the present invention, an electrical connector 1′ comprise an insulative housing 10′, a plurality of contacts 20′, a middle grounding member 30′, an inner shell 40′ and an outer shell 50′ too; wherein the insulative housing 10′, the middle grounding member 30′, and the inner shell 40′ is similar to them described in the first embodiment, there will not be described hereinafter. The difference between the second embodiment and the first embodiment will be described in detail hereinafter.

On the one hand, referring to FIG. 9, different from the first embodiment, the outer shell 50′ is not formed with said dodge portions 521. On the other hand, referring to FIG. 10, different from the first embodiment, the design of extension portions 205′ is different from that in the first embodiment. In detail, firstly, the extension portion 205′ of the superspeed differential signal contacts 221′ is longer than that of the low-frequency signal contacts 222′. Secondly, the extension portions 205′ of the power contacts 21′ are widened at the position corresponding the narrow extension portions 205′ of adjacent signal contacts 22′.

In summary, the signal contacts 22, 22′ in the present invention are designed with narrower extension portions 205, 205′, which can not only provide large spaces therebetween for full molding the insulative housing 10, 10′, but also adjust impedance matching of the contacts 20, 20′ to their best for high frequency signal transmission. Besides, the power contacts 21′ adjacent to the signal contacts 22′ are widened, which can decrease electric impedance and increase current transmission. Moreover, the contact portions 203, 203′ used to contact with the mating contacts of the mating connector keep original width to insure stable connecting therebetween.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An electrical connector, comprising:
an insulative housing having a body portion and a mating portion forwardly extending from the body portion;
a plurality of contacts retained in the insulative housing, each contact having a contact portion exposed on the mating portion and an extension portion extending backwardly from a rear end of the contact portion;
wherein the contacts comprise signal contacts, and in a transverse direction of the insulative housing, the contact portions of the signal contacts are wider than the extension portions of the signal contacts.

2. The electrical connector as claimed in claim 1, wherein the contacts are insert-molded in the insulative housing, and at least a part of each extension portion is insert-molded in the body portion.

3. The electrical connector as claimed in claim 2, wherein the mating portion is a mating tongue, and the contact portions and a front part of each extension portion are supported by the mating tongue.

4. The electrical connector as claimed in claim 1, wherein the contact further has a connecting portion extending from a rear end of the extension portion and a tail portion extending from the connecting portion, the connecting portion has a level portion connecting with the extension portion and a bending portion connecting with the tail portion, and in the transverse direction, the contact portion and the level portion have same width, the tail portion is narrower than the level portion.

5. The electrical connector as claimed in claim 1, wherein the contact portions of all contacts have same width, and the extension portions of the signal contacts is narrower than that of the other contacts.

6. The electrical connector as claimed in claim 5, wherein the contacts comprise power contacts adjacent to the signal contacts, the extension portions of the power contacts is same to or wider than the contact portions.

7. The electrical connector as claimed in claim 1, wherein the mating portion is a mating tongue, and the contacts are arranged in two rows which are located at upper and lower sides of the mating tongue respectively, the contacts in each row comprise two grounding contacts at two lateral sides, two pairs of superspeed differential signal contacts adjacent two grounding contacts respectively, two power contacts arranged at internal side of the superspeed differential signal contacts, and four low-frequency signal contacts between the power contacts, and the contacts in two rows are identical in signal transmission except that they are arranged reversely.

8. The electrical connector as claimed in claim 7, wherein the electrical connector further comprising a middle grounding member located between two rows of the contacts.

9. The electrical connector as claimed in claim 1, wherein further comprises an inner shell surrounding the insulative housing and an outer shell covering the inner shell, the inner shell and the mating portion defines a receiving space therebetween, and the inner shell is provided with two pairs of spring arms protruding to the receiving space from upper and lower sides thereof.

10. The electrical connector as claimed in claim 9, wherein the outer shell is formed with two pairs of dodge portions corresponding to the spring arms, and the dodge portions protrude outwardly from upper and lower walls of the outer shell.

11. An electrical connector, comprising:
an insulative housing having a body portion and a mating portion forwardly extending from the body portion;
a plurality of contacts retained in the insulative housing, each contact having a contact portion exposed on the mating portion and an extension portion extending backwardly from a rear end of the contact portion;
wherein the contacts comprise signal contacts and grounding contacts two sides of the signal contacts, and in a transverse direction of the insulative housing, the contact portions of the signal contacts and the grounding contacts have same width, and the extension portions of the signal contacts are narrower than that of the grounding contacts.

12. The electrical connector as claimed in claim 11, wherein in the transverse direction of the insulative housing, the contact portions of the signal contacts is wider than the extension portions of the signal contacts.

13. The electrical connector as claimed in claim 12, wherein the contacts are insert-molded in the insulative housing, and at least a part of each extension portion is insert-molded in the body portion.

14. The electrical connector as claimed in claim 13, wherein the mating portion is a mating tongue, and the contact portions and a front part of each extension portion are supported by the mating tongue.

15. The electrical connector as claimed in claim 11, wherein the contact further has a connecting portion extending from a rear end of the extension portion and a tail portion extending from a rear end of the connecting portion, the connecting portion has a level portion connecting with the extension portion and a bending portion connecting with the tail portion, and in the transverse direction, the contact portion and the level portion have same width, the tail portion is narrower than the level portion.

16. The electrical connector as claimed in claim 12, wherein the contacts further comprise power contacts adjacent to the signal contacts, and the width of the extension portions of the power contacts is same to or wider than that of the contact portions.

17. The electrical connector as claimed in claim 11, wherein the mating portion is a mating tongue, and the contacts are arranged in two rows which are located at upper and lower sides of the mating tongue respectively, the contacts in each row comprise two grounding contacts at two lateral sides, two pairs of superspeed differential signal contacts adjacent two grounding contacts respectively, two power contacts arranged at internal side of the superspeed differential signal contacts, and four low-frequency signal contacts between the power contacts, and the contacts in two rows are identical in signal transmission except that they are arranged reversely.

18. The electrical connector as claimed in claim 17, wherein the electrical connector further comprising a middle grounding member located between two rows of the contacts.

19. The electrical connector as claimed in claim 11, wherein further comprises an inner shell surrounding the insulative housing and an outer shell covering the inner shell, the inner shell and the mating portion defines a receiving space therebetween, and the inner shell is provided with two pairs of spring arms protruding to the receiving space from upper and lower sides thereof.

20. The electrical connector as claimed in claim 19, wherein the outer shell is formed with two pairs of dodge portion corresponding to the spring arms, and the dodge portions protrude outwardly from upper and lower walls of the outer shell.
